(19) United States
(12) Patent Application Publication
(10) Pub. No.: US 2025/0254111 A1
(43) Pub. Date: Aug. 7, 2025

(54) METHOD AND APPARATUS OF SUPPORTING QUALITY OF EXPERIENCE (QoE) MEASUREMENT COLLECTION

(71) Applicant: LENOVO (BEIJING) LIMITED, Beijing (CN)

(72) Inventors: Mingzeng DAI, Shanghai (CN); Lianhai WU, Beijing (CN); Congchi ZHANG, Shanghai (CN); Le YAN, Shanghai (CN); Xiaoying XU, Beijing (CN)

(21) Appl. No.: 18/855,969

(22) PCT Filed: May 26, 2022
(86) PCT No.: PCT/CN2022/095196

§ 371 Date: Oct. 10, 2024

(51) Int. Cl. H04L 41/5067; H04W 24/10; H04W 76/27

(52) U.S. Cl. CPC H04L 41/5067; H04W 24/10; H04W 76/27

(57) ABSTRACT

Embodiments of the present application relate to a method and apparatus of supporting quality of experience (QoE) measurement collection. An exemplary method may include: receiving, from a core network (CN) node, first identification information of QoE measurement during an initial user equipment (UE) context setup procedure of a UE; receiving, from the UE transited into a radio resource control (RRC) connected state from a RRC idle state, a report of the QoE measurement and second identification information of the QoE measurement; and identifying the report of the QoE measurement according to the first identification information and the second identification information.

### TECHNICAL FIELD

Embodiments of the present application generally relate to wireless communication technology, especially to a method and apparatus of supporting quality of experience (QoE) measurement collection.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In 3GPP release (Rel)-17, the basic mechanism for NR QoE is specified. However, only the QoE measurement configuration and reporting in radio resource control (RRC) _CONNECTED state (or RRC connected state) is supported Rel-17. It is expected that the support for QoE measurement configuration and reporting in RRC_IDLE state, e.g., for multicast/broadcast services (MBS) will be addressed in Rel-18. For example, for QoE measurement in RRC_IDLE state (or RRC idle state), when a user equipment (UE) returns RRC_CONNECTED state, how the gNB identifies the QoE measurement report needs to be solved.

Given the above, the industry desires technology to support QoE measurement collection in RRC_IDLE state, e.g., for MBS.

### SUMMARY OF THE APPLICATION

One objective of the embodiments of the present application is to provide a technical solution of support QoE measurement collection, e.g., a method and apparatus of supporting QoE measurement collection in RRC_IDLE state.

Some embodiments of the present application provide a radio access network (RAN) node, e.g., a gNB, which includes: a transceiver; and a processor coupled to the transceiver, wherein the processor is configured to: receive, from a CN node, first identification information of QoE measurement during an initial UE context setup procedure of a UE; receive, from the UE transited into a RRC connected state from a RRC idle state, a report of the QoE measurement and second identification information of the QoE measurement; and identify the report of the QoE measurement according to the first identification information and the second identification information.

In some embodiments of the present application, both the first identification information and the second identification information includes information identifying QoE measurement configuration and report between RAN node and UE. According to some embodiments of the present application, the first identification information may further include information identifying QoE measurement configuration between RAN node and CN or between RAN node and operation administration and maintenance (OAM), and the information identifying QoE measurement configuration between RAN node and CN or between RAN node and OAM is associated with the information identifying QoE measurement configuration and report between RAN node and UE. An example of the information identifying QoE measurement configuration and report between RAN node and UE is a measurement configuration application layer identifier (ID).

In some embodiments of the present application, both the first identification information and the second identification information includes information identifying QoE measurement configuration between RAN node and CN or between RAN node and OAM. An example of the information identifying QoE measurement configuration between RAN node and CN or between RAN node and OAM is QoE reference.

In some embodiments of the present application, the first identification information is transmitted to the CN before the UE is transited into the RRC idle state, and the second identification information is transmitted to the UE before the UE is transited into the RRC idle state.

In some embodiments of the present application, information indicating the QoE measurement performed by the UE in the RRC idle state is transmitted to the UE before the UE is transited into the RRC idle state.

In some embodiments of the present application, information indicating the QoE measurement performed by the UE in the RRC idle state is also transmitted to the CN node during the UE context release procedure.

In some embodiments of the present application, the RAN node is a serving gNB of the UE or a receiving gNB of the UE.

Some other embodiments of the present application provide a UE, which includes: a transceiver; and a processor coupled to the transceiver, wherein the processor is configured to cooperate with the transceiver to: receive, from a first RAN node, information indicating QoE measurement performed by the UE in a RRC idle state before the UE is transited into the RRC idle state; and transmit, to a second RAN node, a report of the QoE measurement and identification information of the QoE measurement after the UE is transited into a RRC connected state from the RRC idle state, wherein the first RAN node and the second RAN node are the same or different.

In some embodiments of the present application, the processor is configured to: receive the identification information of the QoE measurement before the UE is transited into the RRC idle state.

In some embodiments of the present application, the identification information of the QoE measurement includes information identifying QoE measurement configuration and report between RAN node and UE. An example of the information identifying QoE measurement configuration and report between RAN node and UE is a measurement configuration application layer ID.

In some embodiments of the present application, the identification information of the QoE measurement includes information identifying QoE measurement configuration between RAN node and CN or between RAN node and OAM. An example of the information identifying QoE measurement configuration between RAN node and CN or between RAN node and OAM is QoE reference.

In some embodiments of the present application, both the first RAN node and the second RAN node are a serving gNB of the UE; or the first RAN node is a last serving gNB of the UE and the second RAN node is a receiving gNB of the UE.

Some yet other embodiments of the present application provide a CN node, which includes: a transceiver; and a processor coupled to the transceiver, wherein the processor is configured to cooperate with the transceiver to: receive, from a first RAN node, identification information of QoE measurement during a UE context release procedure of releasing a UE to a RRC idle state; and transmit, to a second RAN node, the identification information of the QoE measurement during an initial UE context setup procedure of the UE, wherein the first RAN node and the second RAN node are the same or different.

In some embodiments of the present application, the identification information of the QoE measurement includes information identifying QoE measurement configuration and report between RAN node and UE. According to some embodiments of the present application, the identification information of the QoE measurement further includes information identifying QoE measurement configuration between RAN node and CN or between RAN node and OAM, and the information identifying QoE measurement configuration between RAN node and CN or between RAN node and OAM is associated with the information identifying QoE measurement configuration and report between RAN node and UE. An example of the information identifying QoE measurement configuration and report between RAN node and UE is a measurement configuration application layer ID.

In some embodiments of the present application, the identification information of the QoE measurement includes information identifying QoE measurement configuration between RAN node and CN or between RAN node and OAM. An example of the information identifying QoE measurement configuration between RAN node and CN or between RAN node and OAM is QoE reference.

In some embodiments of the present application, information indicating the QoE measurement performed by the UE in the RRC idle state is also received during the UE context release procedure.

In some embodiments of the present application, both the first RAN node and the second RAN node are a serving gNB of the UE; or the first RAN node is a last serving gNB of the UE and the second RAN node is a receiving gNB of the UE.

Embodiments of the present application provide a technical solution of supporting QoE measurement collection, e.g., a method and apparatus of supporting QoE measurement collection for MBS or the like in the RRC idle state. Accordingly, the present application can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application.

FIG. 2 is a flow chart illustrating a method of supporting QoE measurement collection according to some embodiments of the present application.

FIG. 3 illustrates an exemplary procedure of QoE measurement collection according to some embodiments of the present application.

FIG. 4 illustrates another exemplary procedure of QoE measurement collection according to some other embodiments of the present application.

FIG. 5 illustrates a block diagram of an apparatus of supporting QoE measurement collection according to some embodiments of the present application.

FIG. 6 illustrates a block diagram of an apparatus of supporting QoE measurement reporting according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

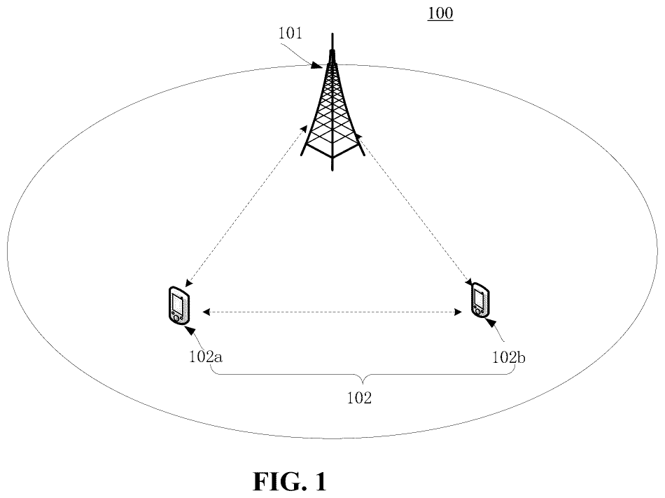

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two terminal device 102 (e.g., a first UE 102a and a second UE 102b) for illustrative purpose. Although a specific number of BSs and terminal devices are illustrated in FIG. 1 for simplicity, it is contemplated that the wireless communication system 100 may include more or less BSs and terminal devices in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a CN node (not shown), e.g., a mobility management entity (MME) or a serving gateway (S-GW), an access and mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node. Each BS may serve a number of UE(s) within a serving area, for example, a cell or a cell sector via a wireless communication link. Neighbor BSs may communicate with each other as necessary, e.g., during a handover procedure for a UE.

The terminal device (or remote apparatus) 102, e.g., the first UE 102a and the second UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the terminal device may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the terminal device may include wearable devices, such as smart watches, fitness bands, optical head-mounted displays, or the like. Moreover, the terminal device may be referred to as a subscriber unit, a mobile, a mobile station, a user, a terminal, a mobile terminal, a wireless terminal, a fixed terminal, a subscriber station, a user terminal, or a device, or described using other terminology used in the art. Herein (through the specification), although “UE” is used exemplarily as a classical terminal device for illustrating the terminal device, it should be understood as any type terminal device.

In 3GPP Rel-17, the basic mechanisms for NR QoE is specified. For example, regarding QoE measurement collection activation and reporting, TS38. 300 specifies the following:
“The feature is activated in the NG-RAN either by direct configuration from the OAM system (management-based activation), or by signalling from the OAM via the Core Network (signalling-based activation), containing UE-associated QoE configuration. One or more QoE measurement collection jobs can be activated at a UE per service type, and each QoE measurement configuration is uniquely identified by a QoE Reference.
For signalling-based QoE measurements, the OAM initiates the QoE measurement activation for a specific UE via the Core Network, and the NG-RAN node receives one or more QoE measurement configurations by means of UE-associated signalling. The QoE measurement configuration for signalling-based activation includes an application layer measurement configuration list and the corresponding information for QoE measurement collection, e.g., QoE Reference, service type, MCE IP Address, Slice Scope, Area Scope, MDT Alignment Information and the indication of available RAN visible QoE metrics. Each application layer measurement configuration is encapsulated in a transparent container. The NG-RAN node forwards the corresponding QoE measurement configuration(s) to the UE in a downlink RRC message containing AppLayerMeasConfig, as specified in TS38.331 [12].
For management-based QoE measurement activation, the OAM sends one or more the QoE measurement configurations to the NG-RAN node. The QoE measurement configuration for management-based activation also includes an application layer measurement configuration list and the corresponding information for QoE measurement collection. Each application layer measurement configuration is encapsulated in a transparent container. The NG-RAN node selects UE(s) that meet the required QoE measurement capability, Area Scope and Slice Scope.
The UE reports QoE measurement results to the NG-RAN node in an uplink RRC message, as specified in TS38.331 [12]. The NG-RAN node transmits the QoE report and the corresponding QoE Reference ID to the MCE.
The QoE measurement collection is handled by application layer measurement configuration and measurement reporting, supported in RRC_CONNECTED state only. Application layer measurement configuration received by the gNB from OAM or CN is encapsulated in a transparent container, which is forwarded to a UE as Application layer configuration in the RRCReconfiguration message (there can be multiple configurations in the same message). Application layer measurement reports received from UE's higher layer are encapsulated in a transparent container and sent to the network in the
MeasurementReportAppLayer message, as specified in TS 38.331 [12]. The UE can send multiple application layer measurement reports to the gNB in one MeasurementReportAppLayer message. In order to allow the transmission of application layer measurement reports which exceed the maximum PDCP SDU size, segmentation of the MeasurementReportAppLayer message may be enabled by the gNB. A measConfigAppLayerId conveyed in the RRC signalling is used to identify the application layer measurement configuration and report between the gNB and the UE. The RRC identifier is mapped to the QoE Reference in the gNB. The application layer measurement report is forwarded to OAM together with the QoE Reference. gNB can release one or multiple application layer measurement configurations from the UE in one RRCReconfiguration message at any time. The UE may additionally be configured by the gNB to report when a QoE measurement session starts or stops for a certain application layer measurement configuration.”

Thus, QoE measurement collection (QMC, also referred to as QoE measurement) in the NG-RAN can be activated by two manners, i.e., management-based activation and signalling-based activation. In the case of management-based activation, the RAN node, e.g., a gNB receives direct configuration from the OAM (or OAM system). In the case of signalling-based activation, the RAN node receives signalling containing UE-associated QoE configuration from the OAM via the CN. The application layer measurement configuration received by the gNB from the OAM or CN is encapsulated in a transparent container in Rel-17, which is forwarded to a UE as application layer configuration in a RRCReconfiguration message (there can be multiple configurations in the same message). Application layer measurement reports received from UE's application layer are encapsulated in a transparent container and sent to the network in a MeasurementReportAppLayer message. In order to allow the transmission of application layer measurement reports which exceed the maximum PDCP SDU size, segmentation of the MeasurementReportAppLayer message may be enabled by the gNB.

TS 38. 300 also specifies QoE measurement continuity for mobility as follows:
“The QoE Measurement Collection continuity for intra-system intra-RAT mobility is supported, with the Area Scope parameters configured by the OAM, where the network is responsible for keeping track of whether the UE is inside or outside the Area Scope. A UE should continue an ongoing measurement even if it leaves the Area Scope, unless the network indicates to the UE to release the QoE configuration.
For RRC_CONNECTED state mobility, the source NG-RAN node may transmit the QoE measurement configuration(s) and/or the information related to the configuration(s) of a specific UE to the target NG-RAN node via XnAP or NGAP. For signaling-based QoE, QoE Reference, MCE IP Address, Measurement Configuration Application layer ID, MDT Alignment Information, Area Scope, Slice Scope and Measurement Status are passed to the target node. For management-based QoE, Measurement Configuration Application Layer ID, MCE IP Address and Measurement Status are passed to the target node. For RRC_INACTIVE state mobility, QoE measurement configuration(s) of a specific UE can be restored from the node hosting the UE context when it resumes to RRC_CONNECTED state. Multiple sets of QoE measurement configurations should be supported during mobility.
For signalling based QoE, at handover to a target gNB which supports QoE, the target gNB decides which application layer measurement configurations to keep and which to release, e.g. based on application layer measurement configuration information received from the source gNB in Xn/NG signalling.
When the UE resumes the connection in a gNB not supporting QoE, the UE releases all application layer measurement configurations.”

It can be seen that, the QoE measurement configuration and measurement reporting supported in RRC_IDLE state has not been specified in Rel-17 yet. However, for some services, e.g., MBS service (i.e., broadcast and multicast), QoE measurement collection in RRC_IDLE state is also important. Therefore, Rel-18 will address the support for QoE measurement configuration and reporting in RRC_IDLE state, e.g., for MBS, as agreed in 3GPP RP-213159:
Specify for QoE measurement configuration and collection in RRC_INACTIVE and RRC_IDLE states for MBS, at least for broadcast service. [RAN3, RAN2]

The issues to be solved include but are not limited to: considering that the UE context and RRC configuration were released in gNB side when the UE was transited into the RRC idle state, when the UE returns the RRC connected state and report the QoE measurement results, how the gNB identifies the QoE measurement report.

At least to support QoE measurement collection in the RRC idle state, embodiments of the present application provide technical solutions of supporting QoE measurement collection, especially a method and apparatus of supporting QoE measurement collection in the RRC idle state.

For example, some embodiments of the present application provide a method, which may be performed by a RAN node, e.g., a serving gNB or a receiving gNB or the like. The exemplary method includes: receiving, from a CN node, first identification information of QoE measurement during an initial UE context setup procedure of a UE; receiving, from the UE transited into a RRC connected state from a RRC idle state, a report of the QoE measurement and second identification information of the QoE measurement; and identifying the report of the QoE measurement according to the first identification information and the second identification information.

Some other embodiments of the present application provide another method, which may be performed by a UE or the like. The exemplary method includes: receiving, from a first RAN node, information indicating QoE measurement performed by the UE in a RRC idle state before the UE is transited into the RRC idle state; and transmitting, to a second RAN node, a report of the QoE measurement and identification information of the QoE measurement after the UE is transited into a RRC connected state from the RRC idle state. The first RAN node and the second RAN node are the same or different. For example, the first RAN node and the second RAN node are the same and both are a serving gNB of the UE when no cell reselection occurs; or the first RAN node is the last serving gNB of the UE and the second RAN node is the receiving gNB of the UE when cell reselection occurs due to the UE mobility in the RRC idle state.

Some yet other embodiments of the present application provide yet another method, which may be performed a CN node, e.g., the AMF or the like. The exemplary method includes: receiving, from a first RAN node, identification information of QoE measurement during a UE context release procedure of releasing a UE to a RRC idle state; and transmitting, to a second RAN node, the identification information of the QoE measurement during an initial UE context setup procedure of the UE. Similarly, the first RAN node and the second RAN node are the same and both are the serving gNB of the UE when no cell reselection happens; or are different when cell reselection happens, wherein the first RAN node is the last serving gNB of the UE and the second RAN node is the receiving gNB of the UE.

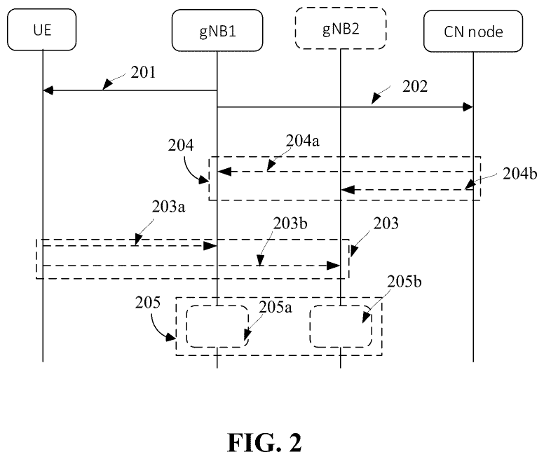

FIG. 2 is a flow chart illustrating a method of supporting QoE measurement collection according to some embodiments of the present application. Although the method is illustrated in a system level among a CN node (e.g., an AMF) in the CN side, at least one RAN node (e.g., NG-RAN node) in the RAN side (e.g., a serving gNB when no cell reselection happens or a last serving gNB and a receiving gNB when cell reselection happens), and a UE or the like in the remote side; persons skilled in the art should understand that the method implemented in the CN node (or CN side, or CN), RAN node (or RAN side or gNB side or NG-RAN) and UE (or UE side or remote side) can be separately implemented and/or incorporated by other apparatus with the like functions.

Referring to FIG. 2, due to the UE mobility in the RRC idle state, two scenarios are considered, i.e., a scenario of no cell reselection and a scenario of cell reselection. In the scenario of no cell reselection (hereafter, also referred to as the first scenario), only one RAN node, e.g., gNB1 is illustrated, which is the serving gNB of the UE. In the scenario of cell reselection (hereafter, also referred to as “the second scenario”), two RAN nodes, e.g., gNB1 and gNB2 are illustrated, wherein gNB1 is the last serving gNB (also referred to as: anchor gNB or old serving gNB or old gNB or the like) of the UE and gNB2 is the receiving gNB (also referred to as: new serving gNB or new gNB or the like) of the UE. That is, the difference between the two scenarios lies in the RAN node to which the UE returns RRC_CONNECTED state changes due to the UE mobility in the second scenario.

Either in the first scenario or in the second scenario, when sending the UE into the RRC idle state, gNB1 may configure the UE to perform QoE measurement collection in the RRC idle state. Accordingly, in step 201, the UE will receive, from gNB1, information indicating QoE measurement performed by the UE in the RRC idle state (hereafter, also referred to as “indication of QoE measurement in RRC idle state”) before the UE is transited into the RRC idle state. For example, the indication of QoE measurement in RRC idle state is transmitted from gNB1 and received by the UE in a downlink RRC message, e.g., a RRC release message of releasing the UE into the RRC idle state or in a RRC reconfiguration message.

In some cases, before transitioning into the RRC idle state, the UE has been performing QoE measurement collection in the RRC connected state. The UE may continue using the configuration information of QoE measurement (hereafter, also referred to as “RRC QoE measurement configuration information,” which is configured by the gNB side to the UE side) provided by gNB1 in the RRC connected state. The gNB side can configure the RRC QoE measurement configuration information in response to QoE measurement (or QoE measurement collection) being activated either by direct configuration from the OAM (not shown) (i.e., management-based activation), or by signalling from the OAM via the CN (i.e., signalling-based activation), containing UE-associated QoE configuration.

For management-based QoE measurement activation, the OAM sends one or more QoE measurement configurations to the RAN node, e.g., gNB1. For signalling-based QoE measurements, the OAM initiates the QoE measurement activation for a specific UE via the CN node; and the CN node sends the QoE measurement configuration information to gNB1 for QoE measurement activation. Exemplary QoE measurement configuration information from CN or OAM (also referred to as “CN/OAM QoE measurement configuration information”) includes:

QoE Reference: which is used to identify a QoE measurement between gNB and CN or between gNB and OAM;

Service Type: which indicates the service type of QoE measurements;

Container for Application Layer Measurement Configuration: which contains application layer measurement configuration; and

Area Scope: the area scope of the QoE measurement, which includes a list of cells, tracking area (TA), tracking area ID (TAI), or public land mobile network (PLMN) ID.

Regarding QoE reference, it can be that as defined in clause 5.2 of TS 28.405, which is a OCTET string with SIZE(6). QoE reference consists of mobile country code (MCC), mobile network code (MNC) and QMC ID, where the MCC and MNC are coming with the trace activation request from a management system to identify one PLMN containing the management system, and QMC ID is a 3-bytes Octet string.

According to the QoE measurement information from the CN or OAM, the gNB will provide the corresponding RRC QoE measurement configuration(s) to the UE in a downlink RRC message containing application layer measurement configuration (e.g., AppLayerMeasConfig), which includes:

MeasConfigAppLayerId: the measurement configuration application layer ID which is used to identify the application layer measurement configuration and report between the gNB and the UE; and

Container for Application Layer Measurement Configuration: which contains application layer measurement configuration.

Regarding measurement configuration application layer ID, it can be that as defined in TS 38.331 and is INTEGER (0 . . . 61, . . . ).

Persons skilled in the art should well know that the above information elements (IE) s or parameters are only illustrated as examples, which may change as the evolution of 3GPP specification, and thus should be not used to unduly limit the protection scope of the present application.

In some other embodiments of the present application, regardless of whether the UE performs the QoE measurement in the RRC connected state, gNB1 may provide new RRC QoE measurement configuration information for the UE (may be the same as that used in the RRC connected state), which may be transmitted to the UE together with the indication of QoE measurement in RRC idle state or separated from the indication of QoE measurement in RRC idle state. For example, gNB1 may also include the new RRC QoE measurement configuration information for the UE in the RRC release message or a RRC reconfiguration message separated from the RRC release message. In the case that gNB1 sends new RRC QoE measurement configuration information for the UE during the procedure of releasing the UE into the RRC idle state, the indication of QoE measurement in RRC idle state may be implied in such manner and no explicit indication will be transmitted to the UE.

In response to the indication of QoE measurement in RRC idle state, the UE will use or continue using the RRC QoE measurement configuration to perform QoE measurement in the RRC idle state. When the UE returns the RRC connected state, the UE will report the QoE measurement results in the RRC idle state to the serving gNB in the case of no cell reselection or to the receiving gNB in the case of cell reselection in step 203. The UE will also transmit the identification information of the QoE measurement to the serving gNB or receiving gNB. For example, in step 203a, the UE will transmit to gNB1 a report of the QoE measurement and identification information of the QoE measurement (or referred to as “the identification information of the report of the QoE measurement”) after the UE is transited into the RRC connected state from the RRC idle state in the first scenario. In another example, in step 203b, the UE will transmit to gNB2 a report of the QoE measurement and identification information of the QoE measurement after the UE is transited into the RRC connected state from the RRC idle state in the second scenario.

The identification information of the QoE measurement is various, and is transmitted to both the UE side and the CN side before the UE is transited into the RRC idle state. Accordingly, the UE and CN node will store the received identification information of the QoE measurement respectively. For example, the identification information of the QoE measurement is information identifying QoE measurement configuration and report between RAN node and UE (hereafter, also referred to as “RRC QoE measurement identification information”), e.g., a measurement configuration application layer ID. In another example, the identification information of the QoE measurement is information identifying QoE measurement configuration between RAN node and CN or between RAN node and OAM (hereafter, also referred to as “CN/OAM QoE measurement identification information”), e.g., a QoE reference. gNB1 can obtain the QoE reference from the CN/OAM QoE measurement configuration information, and then transmit it to both the UE side and the CN side before the UE is transited into the RRC idle state. In some other embodiments of the present application, the identification information of the QoE measurement respectively transmitted to the UE side and CN side may be different but are associated with each other, and the gNB can still identify the QoE measurement report by associating them.

Specifically, for the UE side, similar to the indication of QoE measurement in RRC idle state, the identification information of the QoE measurement, e.g., the RRC QoE measurement identification information or CN/OAM QoE measurement identification information, can be received from gNB1 in various manners. For example, the identification information of the QoE measurement can be received in the RRC QoE measurement configuration information, e.g., in the case of the measurement configuration application layer ID. In another example, the identification information of the QoE measurement can be received in the same RRC reconfiguration message of transmitting the RRC QoE measurement configuration information, e.g., in the case of QoE reference. In yet another example, the identification information of the QoE measurement can be received in a RRC message separate from that transmitting the RRC QoE measurement configuration information to the UE, e.g., in a RRC release message in the case of QoE reference.

For the CN side, it is relatively simple. The identification information of the QoE measurement, e.g., the RRC QoE measurement identification information or CN/OAM QoE measurement identification information can be received from gNB1 during a UE context release procedure of releasing the UE to the RRC idle state in step 202, e.g., in a UE context release request message or a UE context release complete message, which also implies the indication of QoE measurement in RRC idle state to the CN node. In some other embodiments of the present application, gNB1 may also transmit the indication of QoE measurement in RRC idle state to the CN node besides the QoE measurement identification information to explicitly indicate to the CN node that the UE is configured to perform the QoE measurement in the RRC idle state.

When the UE requests to return the RRC connected state, in response to a RRC setup procedure between the RAN side and UE side, there will be an initial UE context setup procedure of the UE between the RAN side and CN side, where the stored identification information of the QoE measurement, e.g., RRC QoE measurement identification information or CN/OAM QoE measurement identification information will be transmitted to the RAN side from the CN side in step 204. Considering the UE mobility in the RRC idle state, the UE may request the RRC reconnection to gNB1 in the first scenario or request the RRC reconnection to gNB2 in the second scenario. The CN node will transmit to gNB1 the stored identification information of the QoE measurement during the initial UE context setup procedure in the first scenario in step 204a, or transmit to gNB2 the stored identification information of the QoE measurement during the initial UE context setup procedure in the second scenario in step 204b.

Accordingly, in the RAN side, the RAN node can identify the report of the QoE measurement received from the UE according to the QoE measurement identification information from the CN and that from the UE in step 205. For example, in the first scenario, in step 205a, gNB1 can identify the received report of the QoE measurement according to the QoE measurement identification information from the CN and that from the UE. In the second scenario, in step 205b, gNB2 can identify the received report of the QoE measurement according to the QoE measurement identification information from the CN and that from the UE.

More detailed embodiment of the present application will be illustrated hereafter in view of different identification information of QoE measurement used for identifying the report of QoE measurement performed by the UE in the RRC idle state. In addition, for simplification, no UE mobility in the RRC idle state is considered in the following embodiments, that is, only embodiments in the first scenario are illustrated. Since the difference between the first scenario and the second scenario is only the change of the gNB due to the UE mobility in the RRC idle state, persons skilled in the art can well know how to apply the illustrated solutions in the first scenario to second scenario based on the disclosure and teaching of FIG. 2 and the following embodiments.

According to some embodiments of the present application, RRC QoE measurement identification information is used to identify at least the report of the QoE measurement performed by the UE in the RRC idle state, which will be respectively transmitted to the UE side and CN side by the gNB before the gNB sends the UE into the RRC idle state. Both the UE side and the CN side will store the RRC QoE measurement identification information. The CN node will send the stored RRC QoE measurement identification information to the gNB during an initial UE context setup procedure of the UE. The UE will also transmit the stored RRC QoE measurement identification information to the gNB with the QoE measurement report. Accordingly, the gNB can identify the QoE measurement report based on the RRC QoE measurement identification information from the CN and the UE.

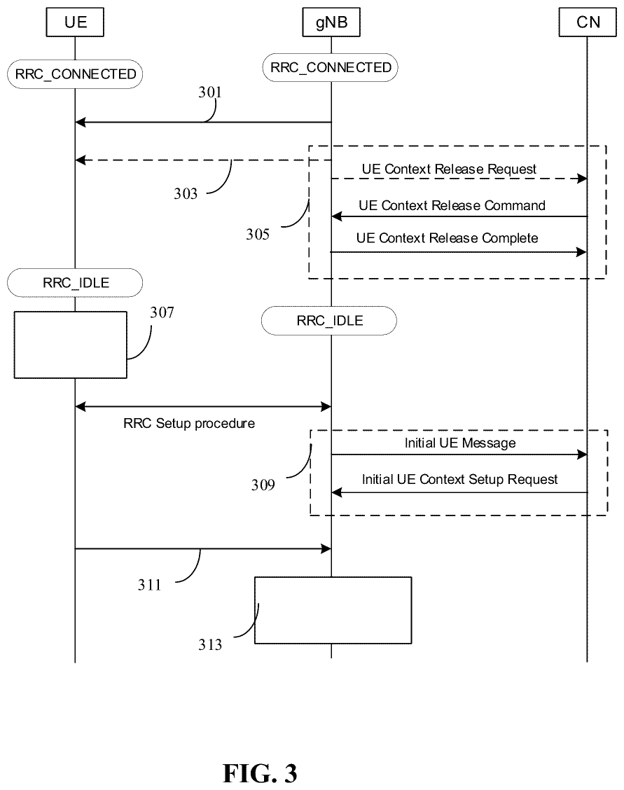

FIG. 3 illustrates an exemplary procedure of QoE measurement collection according to some embodiments of the present application, wherein RRC QoE measurement identification information is used to identify at least the report of the QoE measurement performed by the UE in the RRC idle state.

Referring to FIG. 3, in response to QoE measurement being activated either by direct configuration from the OAM, or by signalling from the OAM via the CN, containing UE-associated QoE configuration, the gNB will provide RRC QoE measurement configuration information to the UE before the UE is transited to the RRC idle state from the RRC connected state in step 301. The RRC QoE measurement configuration information includes the measurement configuration application layer ID, e.g., MeasConfigAppLayerId, which is used as the RRC QoE measurement identification information to identify the QoE measurement configuration and report between the gNB and the UE. The UE will store the RRC QoE measurement configuration information including the RRC QoE measurement identification information, and may perform QoE measurement collection in the RRC connected state accordingly.

In the case that the gNB decides to configure the UE to perform QoE measurement in the RRC idle state, the gNB will send an indication of QoE measurement in RRC idle state to the UE in a downlink RRC message, e.g., in a RRC release message or RRC reconfiguration message to the UE in step 303. In some other embodiments of the present application, the indication of QoE measurement in RRC idle state can be transmitted to the UE together with the RRC QoE measurement configuration information, e.g., both in the RRC release message or a RRC reconfiguration message or the like.

On the other hand, after the gNB decides to configure the UE to perform QoE measurement in the RRC idle state, the gNB will also provide identification information of QoE measurement to the CN node, which is the same or associated with the identification information of QoE measurement to the UE. For example, the gNB also provides the RRC QoE measurement identification information to the CN node, e.g., the AMF, which is the same as that provided to the UE, e.g., the MeasConfigAppLayerId. The gNB may transmit the RRC QoE measurement identification information to the CN node during the UE context release procedure in step 305, which will release the UE to the RRC idle state from the RRC connected state. The RRC QoE measurement identification information can be included in a UE context release request message or a UE context release complete message to the CN node. In some embodiments of the present application, the gNB may transmit the entire RRC QoE measurement configuration information including the RRC QoE measurement identification information to the CN node.

The RRC QoE measurement identification information to the CN node also implies that the UE is configured to perform QoE measurement in the RRC idle state. However, in some other embodiments of the present application, besides the RRC QoE measurement identification information to the CN node, the gNB may also provide the indication of QoE measurement in RRC idle state to the CN node, explicitly indicating the CN node that the UE is configured to perform QoE measurement in the RRC idle state. The indication of QoE measurement in RRC idle state can be transmitted to the CN node together with or separated from the RRC QoE measurement identification information, e.g., both in the UE context release request message or UE context release complete message to the CN node.

In some other embodiments of the present application, the gNB may also transmit the CN/OAM QoE measurement identification information, e.g., the QoE reference to the CN node during the UE context release procedure. Similarly, the gNB may transmit the entire CN/OAM QoE measurement configuration information including the CN/OAM QoE measurement identification information to the CN node in some cases.

Different from the legacy technology, the UE will not release the RRC QoE measurement configuration information. Instead, the UE will store (or continue storing) the RRC QoE measurement configuration information with the RRC QoE measurement identification information in the RRC idle state, and will perform (or continue perform) the QoE measurement in the RRC idle state based on the RRC QoE measurement configuration information accordingly in step 307.

For example, when the UE enters the RRC_IDLE state, the RRC layer of the UE will indicate the upper layer (upper than the RRC layer, e.g. the application layer) of the UE that the UE is in RRC_IDLE state and the QoE measurement in RRC_IDLE is configured. The RRC layer may also provide the RRC QoE measurement identification information, e.g., MeasConfigAppLayerId to the upper layer. The upper layer of the UE will store the MeasConfigAppLayerId for the QoE measurement. In some other embodiments of the present application, the RRC layer, rather than the upper layer of the UE will store the RRC QoE measurement identification information, or even the entire RRC QoE measurement configuration information including the RRC QoE measurement identification information.

When the UE requests to return the RRC connected state via a RRC setup procedure between the UE and gNB, the CN node will provide the stored RRC QoE measurement identification information, e.g., the MeasConfigAppLayerId to the gNB during the initial UE context setup procedure between the gNB and the CN node in step 309, e.g., in the initial UE context setup request message. In the case that the CN node stored the entire RRC QoE measurement configuration information, the CN node may transmit the entire RRC QoE measurement configuration information or only the RRC QoE measurement identification information to the gNB.

The CN node may also transmit the stored CN/OAM QoE measurement identification information associated with the RRC QoE measurement identification information, e.g., the QoE reference associated with the MeasConfigAppLayerId to the gNB during the initial UE context setup procedure. Similarly, in the case that the CN node stored the entire CN/OAM QoE measurement configuration information, the CN node may transmit the entire CN/OAM QoE measurement configuration information or only the RRC QoE measurement identification information to the gNB.

After returning the RRC connected state, the UE will report the QoE measurement results with the RRC QoE measurement identification information, e.g., MeasConfigAppLayerId in step 311. The gNB will identify the QoE measurement report to decide for which QoE measurement the QoE measurement report is according to the RRC QoE measurement identification information from the CN node and the UE in step 313. The gNB may further map the QoE measurement report with the CN/OAM QoE measurement configuration information received from the CN node, e.g., the received QoE reference. Accordingly, the gNB will know for which QoE measurement the QoE measurement report is and send the QoE measurement report of the QoE measurement to the OAM directly or via the CN node.

According to some other embodiments of the present application, CN/OAM QoE measurement identification information rather than RRC QoE measurement identification information is used to identify at least the report of the QoE measurement performed by the UE in the RRC idle state, which will be respectively transmitted to the UE side and CN side by the gNB before the gNB sends the UE into the RRC idle state. Both the UE side and the CN side will store the CN/OAM QoE measurement identification information. The CN node will send the stored CN/OAM QoE measurement identification information to the gNB during an initial UE context setup procedure of the UE. The UE will also transmit the stored CN/OAM QoE measurement identification information to the gNB with the QoE measurement report. t. Accordingly, the gNB can identify the QoE measurement report based on the CN/OAM QoE measurement identification information from the CN and the UE.

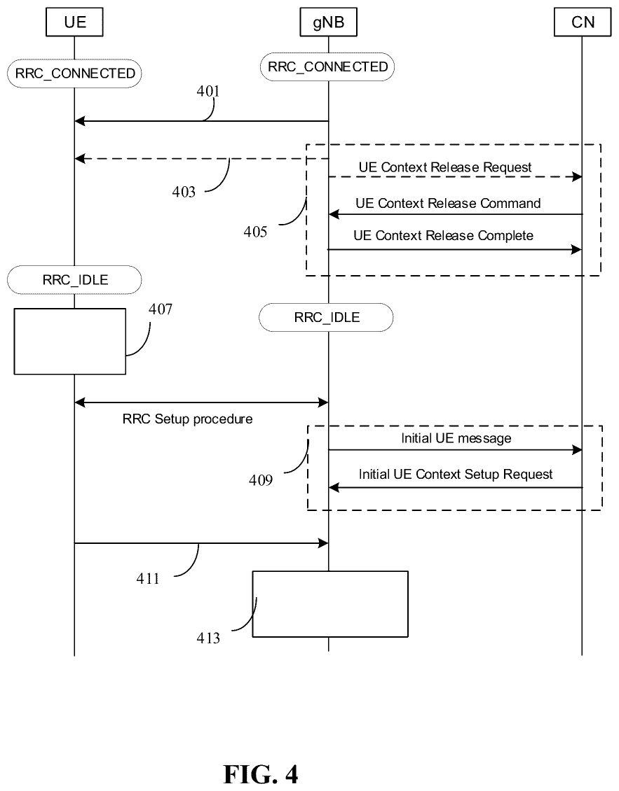

FIG. 4 illustrates another exemplary procedure of QoE measurement collection according to some other embodiments of the present application, wherein CN/OAM QoE measurement identification information is used to identify at least the report of the QoE measurement performed by the UE in the RRC idle state.

Referring to FIG. 4, based on the CN/OAM QoE measurement information, the gNB will provide RRC QoE measurement configuration information to the UE before the UE is transited to the RRC idle state from the RRC connected state in step 401. The RRC QoE measurement configuration information includes the measurement configuration application layer ID, e.g., MeasConfigAppLayerId, which is used to identify the application layer measurement configuration and report between the gNB and the UE. The UE will store the RRC QoE measurement configuration information, and perform QoE measurement and report in the RRC connected state accordingly.

In the case that the gNB decides to configure the UE to perform QoE measurement in the RRC idle state, the gNB will send an indication of QoE measurement in RRC idle state to the UE in a downlink RRC message, e.g., in a RRC release message to the UE in step 403. In some other embodiments of the present application, the indication of QoE measurement in RRC idle state can be transmitted to the UE together with the RRC QoE measurement configuration information, e.g., both in the RRC release message or a RRC reconfiguration message.

To identify the report of the QoE measurement performed in the RRC idle state, the gNB will also transmit the CN/OAM QoE measurement identification information, e.g., QoE reference to the UE before the UE is transited to the RRC idle state. The CN/OAM QoE measurement identification information can be transmitted to the UE together with or separate from at least one of the indication of QoE measurement in RRC idle state and RRC QoE measurement configuration information. In some embodiments of the present application, the gNB may transmit the entire CN/OAM QoE measurement configuration information including the QoE reference to the UE.

On the other hand, after the gNB decides to configure the UE to perform QoE measurement in the RRC idle state, the gNB will also provide identification information of QoE measurement to the CN node, which is the same or associated with the identification information of QoE measurement to the UE. For example, the gNB also provides the CN/OAM QoE measurement identification information to the CN node, e.g., the AMF, which is the same as that provided to the UE, i.e., the QoE reference. The gNB may transmit the CN/OAM QoE measurement identification information to the CN node during the UE context release procedure in step 405, which will release the UE to the RRC idle state from the RRC connected state. The CN/OAM QoE measurement identification information can be included in a UE context release request message or a UE context release complete message to the CN node. In some embodiments of the present application, the gNB may transmit the entire CN/OAM QoE measurement configuration information including the CN/OAM QoE measurement identification information to the CN node.

The CN/OAM QoE measurement identification information to the CN node also implies that the UE is configured to perform QoE measurement in the RRC idle state. However, in some other embodiments of the present application, besides the CN/OAM QoE measurement identification information to the CN node, the gNB may also provide the indication of QoE measurement in RRC idle state to the CN node, explicitly indicating to the CN node that the UE is configured to perform QoE measurement in the RRC idle state. The indication of QoE measurement in RRC idle state can be transmitted to the CN node together with or separated from the CN/OAM QoE measurement identification information, e.g., both in the UE context release request message or UE context release complete message to the CN node.

Similarly, the UE will not release the RRC QoE measurement configuration information and CN/OAM QoE measurement identification information. Instead, the UE will store (or continue storing) the RRC QoE measurement configuration information and the CN/OAM QoE measurement identification information in the RRC idle state, and will perform the QoE measurement in the RRC idle state based on the RRC QoE measurement configuration information accordingly in step 407.

For example, when the UE enters the RRC_IDLE state, the RRC layer of the UE will indicate the upper layer (upper than the RRC layer e.g. the application layer) of the UE that the UE is in RRC_IDLE state and the QoE measurement in RRC_IDLE is configured. The RRC layer may also provide the CN/OAM QoE measurement identification information, e.g., QoE reference to the upper layer. The upper layer of the UE will store the QoE reference for the QoE measurement. In some other embodiments of the present application, the RRC layer, rather than the upper layer of the UE will store the CN/OAM QoE measurement identification information, or even the entire CN/OAM QoE measurement configuration information including the CN/OAM measurement identification information.

When the UE requests to return the RRC connected state via a RRC setup procedure between the UE and gNB, the CN node will provide the stored CN/OAM QoE measurement identification information, e.g., the QoE reference to the gNB during the initial UE context setup procedure between the gNB and the CN node in step 409, e.g., in the initial UE context setup request message. In the case that the CN node stored the entire CN/OAM QoE measurement configuration information, the CN node may transmit the entire RRC QoE measurement configuration information or only the CN/OAM QoE measurement identification information to the gNB.

After returning the RRC connected state, the UE will report the QoE measurement results including the CN/OAM QoE measurement identification information, e.g., the QoE reference in step 411. The gNB will identify the QoE measurement report to decide for which QoE measurement the QoE measurement report is according to the CN/OAM QoE measurement identification information from the CN node and the UE in step 413. Accordingly, the gNB will send the QoE measurement report of the QoE measurement to the OAM directly or via the CN node.

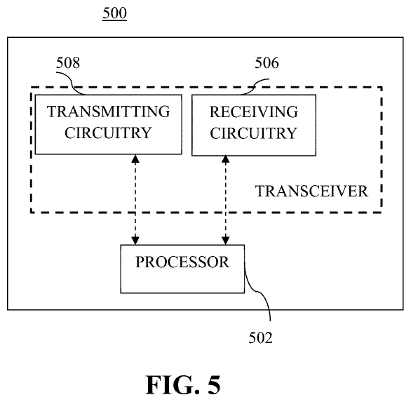

Besides methods, embodiments of the present application also propose an apparatus of supporting QoE measurement collection. FIG. 5 is a block diagram of an apparatus of supporting QoE measurement collection according to some embodiments of the present application.

Referring to FIG. 5, the apparatus 500, e.g., a UE or a RAN node, or a CN node may include at least one processor 502 and at least one transceiver 504. The transceiver 504 may include at least one separate receiving circuitry 506 and transmitting circuitry 508, or at least one integrated receiving circuitry 506 and transmitting circuitry 508. The at least one processor 502 may be a CPU, a DSP, a microprocessor etc.

According to some embodiments of the present application, when the apparatus 500 is a RAN node, e.g., a serving gNB or a receiving gNB, the processor is configured to: receive, from a CN node, first identification information of QoE measurement during an initial UE context setup procedure of a UE; receive, from the UE transited into a RRC connected state from a RRC idle state, a report of the QoE measurement and second identification information of the QoE measurement; and identify the report of the QoE measurement according to the first identification information and the second identification information.

According to some other embodiments of the present application, when the apparatus 500 is a UE, the processor may be configured to: receive, from a first RAN node, information indicating QoE measurement performed by the UE in a RRC idle state before the UE is transited into the RRC idle state; and transmit, to a second RAN node, a report of the QoE measurement and identification information of the QoE measurement after the UE is transited into a RRC connected state from the RRC idle state, wherein the first RAN node and the second RAN node are the same or different.

According to some yet other embodiments of the present application, when the apparatus 500 is a CN node, the processor may be configured to: receive, from a first RAN node, identification information of QoE measurement during a UE context release procedure of releasing a UE to a RRC idle state; and transmit, to a second RAN node, the identification information of the QoE measurement during an initial UE context setup procedure of the UE, wherein the first RAN node and the second RAN node are the same or different.

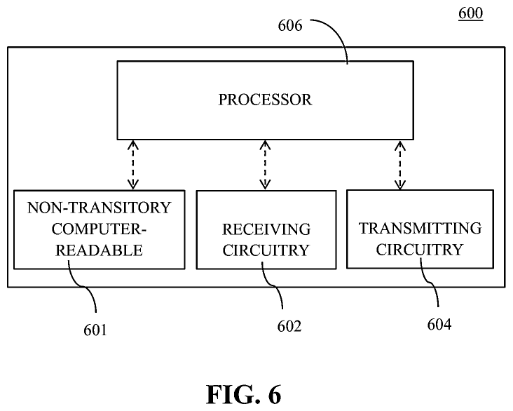

For example, FIG. 6 illustrates a block diagram of an apparatus 600 of supporting QoE measurement reporting according to some other embodiments of the present application.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The apparatus 600 may be a RAN node or a terminal device (e.g., a UE) or a CN node configured to perform a method illustrated in the above or the like.

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 can be combined into a single device, such as a transceiver. The processor 606 may be a CPU, a DSP, a microprocessor etc. In certain embodiments of the present application, the apparatus 600 may further include an input device, a memory, and/or other components.

In some embodiments of the present application, the non-transitory computer-readable medium 601 may have stored thereon computer-executable instructions to cause the processor 606 to implement the method with respect to the RAN node, e.g., a serving gNB or a receiving gNB as described above. For example, the computer-executable instructions, when executed, cause the processor 606 interacting with receiving circuitry 602 and transmitting circuitry 604, so as to perform the steps with respect to a RAN node as depicted above.

In some other embodiments of the present application, the non-transitory computer-readable medium 601 may have stored thereon computer-executable instructions to cause a processor to implement the method with respect to the UE as described above. For example, the computer-executable instructions, when executed, cause the processor 606 interacting with receiving circuitry 602 and transmitting circuitry 604, so as to perform the steps with respect to a UE as depicted above.

In some yet other embodiments of the present application, the non-transitory computer-readable medium 601 may have stored thereon computer-executable instructions to cause a processor to implement the method with respect to the CN node as described above. For example, the computer-executable instructions, when executed, cause the processor 606 interacting with receiving circuitry 602 and transmitting circuitry 604, so as to perform the steps with respect to a CN node as depicted above.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A radio access network (RAN) node for wireless communication, comprising:
at least one memory; and
at least one processor coupled with the at least one memory and configured to cause the RAN node to:
receive, from a core network (CN) node, first identification information of a quality of experience (QoE) measurement during an initial user equipment (UE) context setup procedure of a UE;
receive, from the UE after the UE transited into a radio resource control (RRC) connected state from an RRC idle state, a report of the QoE measurement and second identification information of the QoE measurement; and
identify the report of the QoE measurement according to the first identification information and the second identification information.

2. The RAN node of claim 1, wherein, both the first identification information and the second identification information includes information identifying the QoE measurement configuration and report between the RAN node and the UE.

3. The RAN node of claim 2, wherein, the first identification information further includes information identifying QoE measurement configuration between the RAN node and the CN or between RAN node and an operation administration and maintenance (OAM), and the information identifying QoE measurement configuration between the RAN node and the CN or between the RAN node and the OAM is associated with the information identifying the QoE measurement configuration and report between the RAN node and the UE.

4. The RAN node of claim 2, wherein, the information identifying the QoE measurement configuration and report between the RAN node and the UE is a measurement configuration application layer identifier (ID).

5. The RAN node of claim 1, wherein, both the first identification information and the second identification information includes an information identifying QoE measurement configuration between the RAN node and the CN or between the RAN node and an operation administration and maintenance (OAM).

6. The RAN node of claim 5, wherein, the information identifying the QoE measurement configuration between the RAN node and the CN or between the RAN node and the OAM is a QoE reference.

7. The RAN node of claim 1, wherein, the first identification information is transmitted to the CN before the UE is transited into the RRC idle state, and the second identification information is transmitted to the UE before the UE is transited into the RRC idle state.

8. A user equipment (UE) for wireless communication, comprising:
at least one memory; and
at least one processor coupled with the at least one memory and configured to cause the UE to:
receive, from a first radio accession network (RAN) node, information indicating a quality of experience (QoE) measurement performed by the UE in a radio resource control (RRC) idle state before the UE is transited into the RRC idle state; and
transmit, to a second RAN node, a report of the QoE measurement and identification information of the QoE measurement after the UE is transited into an RRC connected state from the RRC idle state, wherein the first RAN node and the second RAN node are the same node or different nodes.

9. The UE of claim 8, wherein, the at least one processor is further configured to cause the UE to:
receive the identification information of the QoE measurement before the UE is transited into the RRC idle state.

10. The UE of claim 8, wherein, the identification information of the QoE measurement includes information identifying a QoE measurement configuration and report between the RAN node and the UE.

11. The UE of claim 10, wherein, the information identifying the QoE measurement configuration and report between the RAN node and the UE is a measurement configuration application layer identifier (ID).

12. The UE of claim 8, wherein, the identification information of the QoE measurement includes information identifying a QoE measurement configuration between the RAN node and a core network (CN) or between the RAN node and an operation administration and maintenance (OAM).

13. The UE of claim 12, wherein, the information identifying the QoE measurement configuration between the RAN node and the CN or between the RAN node and the OAM is a QoE reference.

14. A core network (CN) node for wireless communication, comprising:
at least one memory; and
at least one processor coupled with the at least one memory and configured to cause the CN to:
receive, from a first radio access network (RAN) node, identification information of a quality of experience (QoE) measurement during a user equipment (UE) context release procedure of releasing a UE to a radio resource control (RRC) idle state; and
transmit, to a second RAN node, the identification information of the QoE measurement during an initial UE context setup procedure of the UE, wherein the first RAN node and the second RAN node are the same or different.

15. The CN node of claim 14, wherein, the identification information of the QoE measurement includes an information identifying QoE measurement configuration and report between the RAN node and the UE.

16. A method performed by a radio access network (RAN) node, the method comprising:
receiving, from a core network (CN) node, first identification information of a quality of experience (QoE) measurement during an initial user equipment (UE) context setup procedure of a UE;
receiving, from the UE after the UE transited into a radio resource control (RRC) connected state from an RRC idle state, a report of the QoE measurement and second identification information of the QoE measurement; and
identifying the report of the QoE measurement according to the first identification information and the second identification information.

17. The method of claim 16, wherein both the first identification information and the second identification information includes an information identifying QoE measurement configuration between the RAN node and the CN or between the RAN node and an operation administration and maintenance (OAM).

18. The method of claim 17, wherein the information identifying the QoE measurement configuration between the RAN node and the CN or between the RAN node and the OAM is a QoE reference.

19. The method of claim 16, wherein both the first identification information and the second identification information includes information identifying the QoE measurement configuration and report between the RAN node and the UE.

20. The method of claim 16, wherein the first identification information is transmitted to the CN before the UE is transited into the RRC idle state, and the second identification information is transmitted to the UE before the UE is transited into the RRC idle state.
